(19) United States
(12) Patent Application Publication
(10) Pub. No.: US 2012/0316926 A1
(43) Pub. Date: Dec. 13, 2012

(54) METHOD AND APPARATUS FOR DETERMINING OPERATIONAL ENVIRONMENTAL IMPACTS OF NON-RESIDENTIAL BUILDINGS

(75) Inventors: Maria Louise Atkinson, Woollahra (AU); Che Shiva Wall, Crows Nest (AU)

(73) Assignee: Lend Lease Sustainability Solutions Pty Limited, Millers Point (AU)

(21) Appl. No.: 13/492,704

(22) Filed: Jun. 8, 2012

(30) Foreign Application Priority Data
Jun. 10, 2011 (AU) 2011902306

(51) Int. Cl. G06Q 30/02

(52) U.S. Cl. 705/7.36

(57) ABSTRACT

Disclosed is a method (200) for capturing, storing, analysing and reporting operational environmental impacts of a non-residential building (102), the method comprising the steps of determining (201) a set of building specific data capture metrics, environmental externality metrics, and standard denominators that support calculations and reporting compliant with an international standard for Greenhouse Gas reporting and measurement, defining (205) a hierarchical scope for data capture, capturing (207) and characterising data, as directed by a set of software procedures based upon the metrics and executing on a computer platform (125), for the carbon and/or energy intensity of the building (102) and other building related and environmental performance data as specified by the defined data sets, processing (211) the captured data to determine a core data set (130) comprising the originally captured data and common operational intensity data for the building, and storing (213) the core data set on an electronically accessible database (131).

### REFERENCE TO RELATED PATENT APPLICATION(S)

This application claims the benefit under 35 U.S.C. §119 of the filing date of Australian Patent Application No. 2011902306, filed 10 Jun. 2011, hereby incorporated by reference in its entirety as if fully set forth herein.

### TECHNICAL FIELD OF THE INVENTION

The present invention relates generally to mitigation of environmental problems arising from greenhouse gas emissions, and, in particular, to a method and apparatus for characterising environmental sustainability of non-residential buildings.

### BACKGROUND

An increasing number of companies estimate and disclose Greenhouse Gas (GHG) emissions as defined under the Greenhouse Gas Protocol, as well as other climate-change related information, such as risks. However, the absence of internationally-agreed standards results in significant variations in methodologies used and scope of information reported. This ultimately increases the cost of reporting for companies. It also reduces the opportunity to compare performance across companies and industries.

Setting emission reduction targets has also become a widespread practice among companies. Yet, in the absence of a common framework for setting such targets, corporate practices differ widely. As a consequence, the level of ambition of targets and the emissions reductions resulting from their implementation are neither comparable, nor can they be aggregated.

### SUMMARY

It is an object of the present invention to substantially overcome, or at least ameliorate, one or more disadvantages of existing arrangements.

Disclosed are arrangements, referred to as Integrated Core Data Set (or ICDS) arrangements, which seek to address the above problems by storing, analysing and reporting operational environmental impacts of a non-residential building or collection of non-residential buildings over time using standardised metrics and methods, in order to form a core data set, that complies with international carbon accounting guidelines, that can serve a multitude of purposes and audiences from a single core data set.

The ICDS approach has at its core a robust dataset definition (130) and modular approach that is expected to meet current and expected future needs. Analytical modules (116) can be added and refined as needed to provide metrics and industry relevant information that provides clarity and robustness for decision making or stakeholder engagement within a country and across borders. The ICDS arrangements focus on valuable analytics only made possible through the methodology (accurate comparison to peer group) to drive value for those contributing data. As the methodology provides drivers towards better investment decisions, it should also encourage improved accuracy of data reporting.

According to a first aspect of the present invention, there is provided a method, implemented on a computer platform, for capturing, storing, analysing and reporting operational environmental impacts of a non-residential building or collection of non-residential buildings over time, the method comprising the steps of: determining a set of building specific data capture metrics, environmental externality metrics, and standard denominators that support calculations and reporting which are compliant with at least one international standard for Greenhouse Gas reporting and measurement; defining a scope for data capture comprising a hierarchy for classifying data sets as follows: a mandatory data set being a minimum acceptable data collection as defined by the metrics; a preferred data set being a more detailed data collection as defined by the metrics; and an optional data set being detailed data collection as defined by the metrics; capturing and characterising data, as directed by a set of software procedures based upon the metrics and executing on the computer platform, for the carbon and/or energy intensity of the building and other building related and environmental performance data as specified by the defined data sets; processing the captured data to determine a core data set comprising the originally captured data and common operational intensity data for the building; and storing the core data set on an electronically accessible database.

According to another aspect of the present invention, there is provided an apparatus for implementing any of the aforementioned methods.

According to another aspect of the present invention, there is provided a computer program product including a computer readable medium having recorded thereon a computer program for implementing the method described above.

Other aspects of the invention are also disclosed.

### BRIEF DESCRIPTION OF THE DRAWINGS

FIG. 1 shows a functional block/data flow diagram depicting one example of the disclosed ICDS arrangement;

FIG. 2 shows a flow chart of two process fragments, one fragment showing how the ICDS arrangement populates and maintains the ICDS data warehouse, and the other fragment showing how an end user uses the data in the warehouse;

FIGS. 3A and 3B form a schematic block diagram of a general purpose computer system upon which arrangements described can be practiced;

FIGS. 4A, B and C illustrate a core data set shown in FIG. 1; and

FIG. 5 depicts a modular analytic plug-in configured to perform data mining of the core data set and do the necessary processing to generate a particular report.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and the section above relating to prior art arrangements relate to discussions of documents or devices which may form public knowledge through their respective publication and/or use. Such discussions should not be interpreted as a representation by the present inventor(s) or the patent applicant that such documents or devices in any way form part of the common general knowledge in the art.

The current state of affairs is driven by increasing multiple reporting needs, each requiring bespoke data collection (at great cost), which, the Applicant has realized, is not warehoused or accessible to the contributor once submitted.

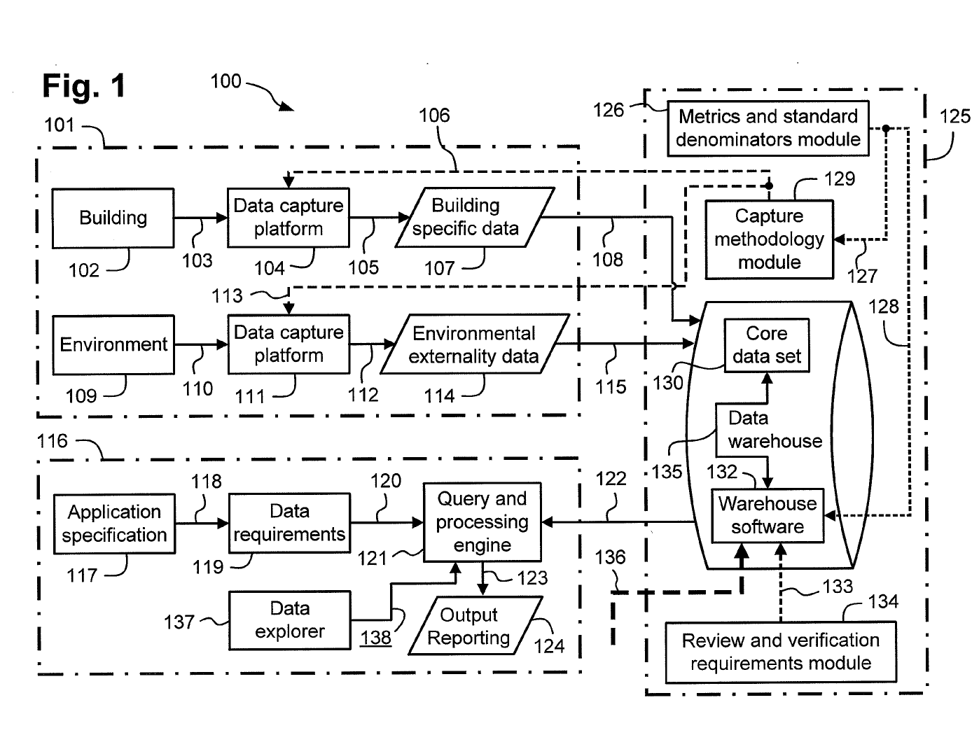

FIG. 1 shows a functional block/data flow diagram depicting one example 100 of the disclosed Integrated Core Data Set (ICDS) arrangement. The ICDS arrangement 100 comprises three main sub-systems, namely a data capture section 101 [also referred to as the data source(s)], multiple modular data analytics sections 116 [also referred to as the data audience(s) or the data user(s)], and an ICDS platform 125.

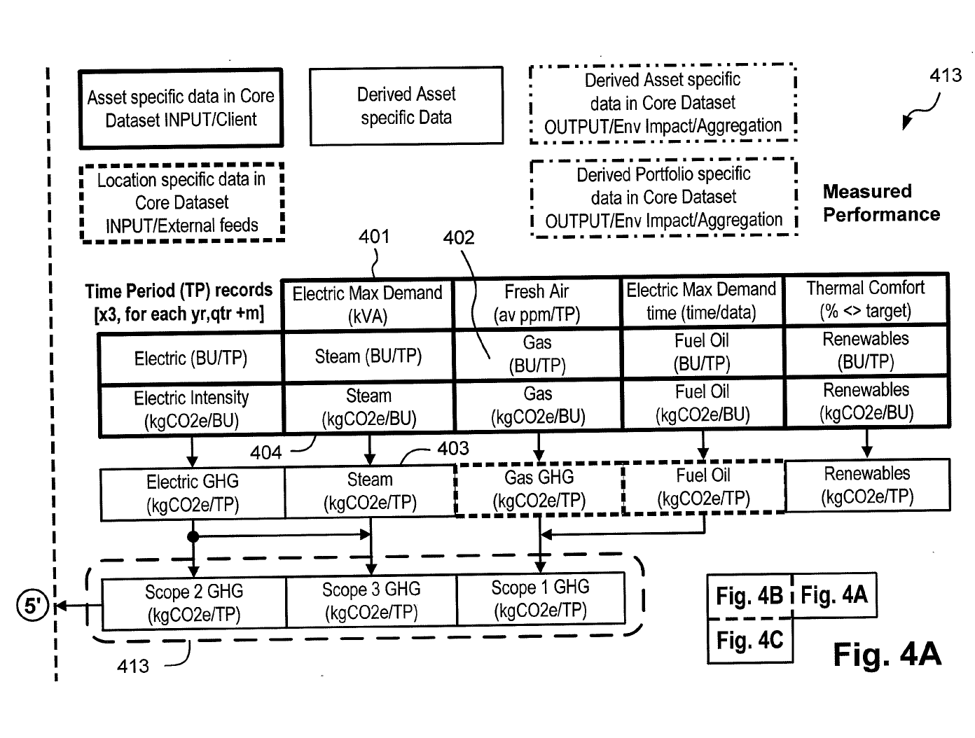

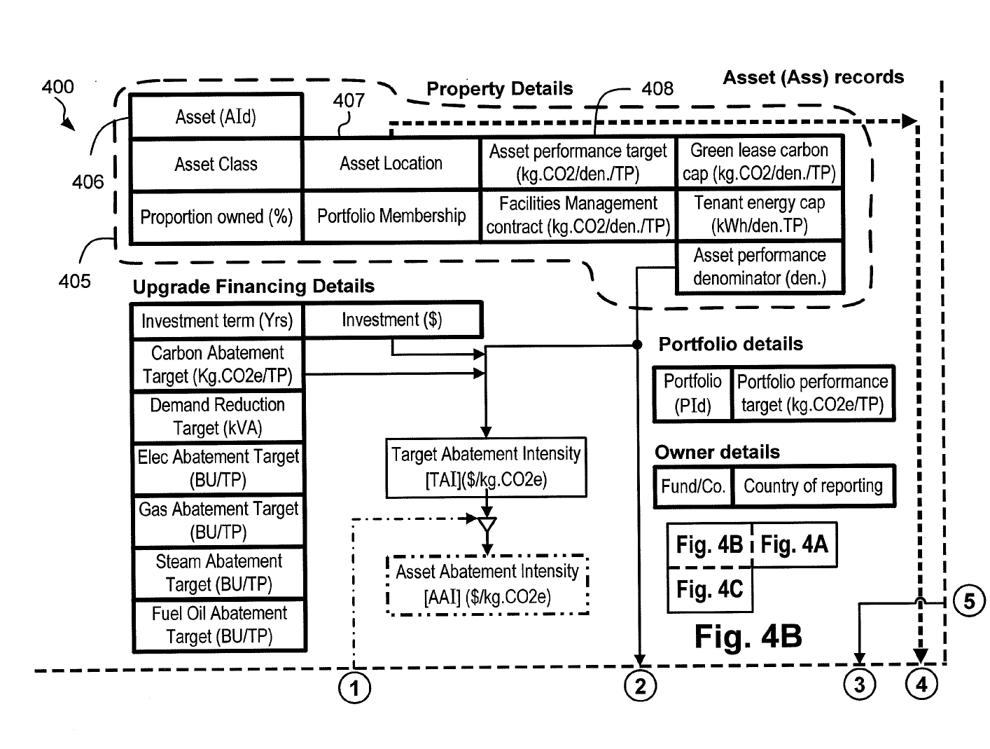

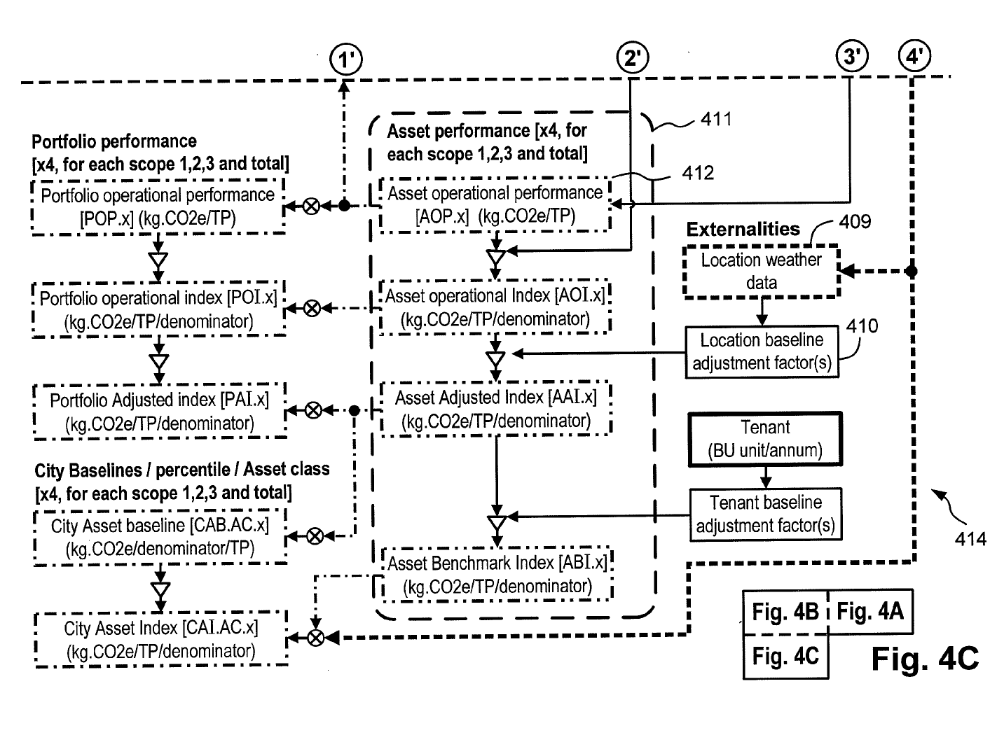

At a high level, the data sources 101 feed data, as depicted by arrows 108, 115 to a data warehouse 131 in the ICDS platform 125. As and if the need arises the data audience 116 extracts, as depicted by an arrow 122, relevant data from the core data set 130 in the data warehouse 131, and processes and analyses 121 the extracted data to output, as depicted by an arrow 123, desired reporting material 124. An example of the core data set 130 is described with reference to FIGS. 4A, B and C.

Taking a more detailed view of the system 100, the ICDS platform functionality is underpinned by a process 126 which determines a set of universally compatible building specific data capture metrics, environmental externality metrics, and standard denominators that support calculations and reporting which are compliant with at least one international standard for Greenhouse Gas reporting and measurement, for example the Greenhouse Gas Protocol, (also referred to as the GHG protocol) information on which may be accessed at web address http://www.ghgprotocol.org/.

A data capture metric specifies which data to capture, and possibly how the data should be captured/measured, and how the measured data should be interpreted and represented with respect to confidence and reliability. An example of a partial data capture metric is [kwh/m²] of electric or [litres per m² per month] of fuel oil. An environmental externality metric is a metric that is common to buildings of similar location and/or similar fuel sources, for example, weather data or applicable carbon intensity of electricity. An example of a standard denominator is floor area in [metres squared] or asset class of the building(s).

The universal applicability of the metrics and standard denominators specified by the process 126 is necessary to ensure that as the metrics and standard denominators develop to meet new circumstances, previously captured data in the core data set 130 remains relevant and applicable. An example of data which meets the aforementioned criteria is provided by the Australian National Greenhouse and Energy Reporting Act 2007, also referred to as NGERS, (which may be accessed at http://www.comlaw.gov.au/Details/C2009C00478). One future anticipated use of such data is carbon trading.

From an audience perspective, the ICDS platform functionality is further underpinned by a process 134 which determines a set of review and verification requirements required by data users 116 to meet the highest standards of independent review where needed. One example of such requirements may be found in NGERS, where data requires independent auditing for sources of fuel use input. The metrics and standard denominators feed, as depicted by dashed arrows 127 and 128, into a capture methodology module 129 and into data warehouse software modules 132 respectively.

The capture methodology module 129 provides rules and guidelines for data capture which ensure that the captured data is consistent with the metrics and standard denominators. Accordingly, data is converted to ensure consistency. For example, the

United States uses [square feet] for floor area measurement, and this would be converted to [square metres]. The module 129 can be implemented in a number of ways such as, for example, a set of software procedures executing on a computer platform which communicates with data capture platforms 104, 111.

In order to understand how this capture methodology module 129 operates, we consider a non-residential building 102 whose operational environmental impact is to be captured. The data capture platform 104, which may be an automated or semi-automatic data acquisition system implemented by suitable software executing on a general purpose computer, or a manual paper-based system, captures building specific data 107 for the building 102, as depicted by arrows 103, 105. An example of such data is [kwh] of electricity used, and floor area of a building.

The data capture platform 104 operates under direction, as depicted by a dashed arrow 106, of a set of software guided procedures provided by the capture methodology module 129. An example of a rule required by the software guided procedures is a requirement for raw/ unadjusted data on fuel usage classified by source, ie electric, gas, steam, oil in order to ensure correct accounting under scope 1, 2, 3 greenhouse gas classifications. The GHG Protocol defines three scopes of emissions as follows:

Scope 1—Direct GHG emissions are emissions from sources that are owned or controlled by the company. For example, emissions from combustion in owned or controlled boilers, furnaces and vehicles;

Scope 2—Accounts for GHG emissions from the generation of purchased electricity by the company;

Scope 3—Optional reporting category that allows for the treatment of all other indirect emissions. They are a consequence of the activities of the company, but occur from sources not owned or controlled by the company. Some examples include third party deliveries, business travel activities and use of sold products and services;

The aforementioned software guided procedures ensure that the captured building specific data 107 is accurately and consistently measured, providing consistency of measurement and comparability of data. A generic example of captured building specific data is quarterly bills for building X at address Y.

The software guided procedures provide for collection of data that is carefully scoped in hierarchical tiers of relevance, and confidence rated to preserve the value of the data both for immediate reporting purposes, and for foreseeable future purposes. An example of hierarchical data is given by classifying the data into three categories such as “mandatory”, “preferred”, and “optional”. The data is confidence rated based on data input being measured or derived from meter readings data as opposed to being estimated data from utility bills. The building specific data 107 is directed (uploaded), as depicted by the arrow 108, to the data warehouse 131 in the ICDS platform 125. The ICDS platform 125 may be implemented as a server in a client server architecture, in which the data capture platforms 104, 111 act as clients or interfaces.

Other building related and environmental externality performance data 114 is captured from other sources including government published data 109, as depicted by arrows 110, 112 by the data capture platform 111 which, similarly to the capture platform 104, may be an automated or semi-automatic data acquisition system implemented on a general purpose computer, or a manual paper-based system. Examples of such data include (a) weather data captured by a Bureau of Meteorology for purposes of year-on-year weather adjustments, and (b) carbon intensity for a given fuel type for a given year. The data capture platform 111 operates under direction, as depicted by a dashed arrow 113, of the set of software guided procedures provided by the capture methodology module 129. An example of a rule within these procedures is a requirement to collect Scope 2 & Scope 3 greenhouse gas emission data associated with electricity supply, including network distribution losses and not just power station losses. This imparts the same qualities of accuracy and consistency to the captured environmental externality data 114 as is provided to the captured building specific data 107. The environmental externality data 114 is directed (uploaded), as depicted by the arrow 115, to the data warehouse 131 in the ICDS platform 125.

At a high level, a data warehouse such as 131 receives data at 108, 115 from the data sources 101. Warehouse software 132 processes and/or supplements the received source data, as depicted by an arrow 135, in order to form the core data set 130, which is ready for end users of the data warehouse 131, such as the data audience(s) 116, to query and analyse (as depicted by the arrow 122). Thus for example the warehouse software 132 determines an asset adjusted index, which is energy converted to a total greenhouse footprint through reference to fuel inputs and environmental intensity of fuel, and further adjusted by local weather data compensation. As a further example, the software 132 also determines a portfolio adjusted index, comprising aggregation of all buildings within a portfolio adjusted by tenant impacts.

The warehouse software 132 is informed by the metrics and standard denominator process 126, as depicted by a dashed arrow 128, as well as by general performance requirements 136 set by the universe of users of the ICDS platform. The warehouse software 132 is also informed by the review and verification requirement process 134, as depicted by a dashed arrow 133.

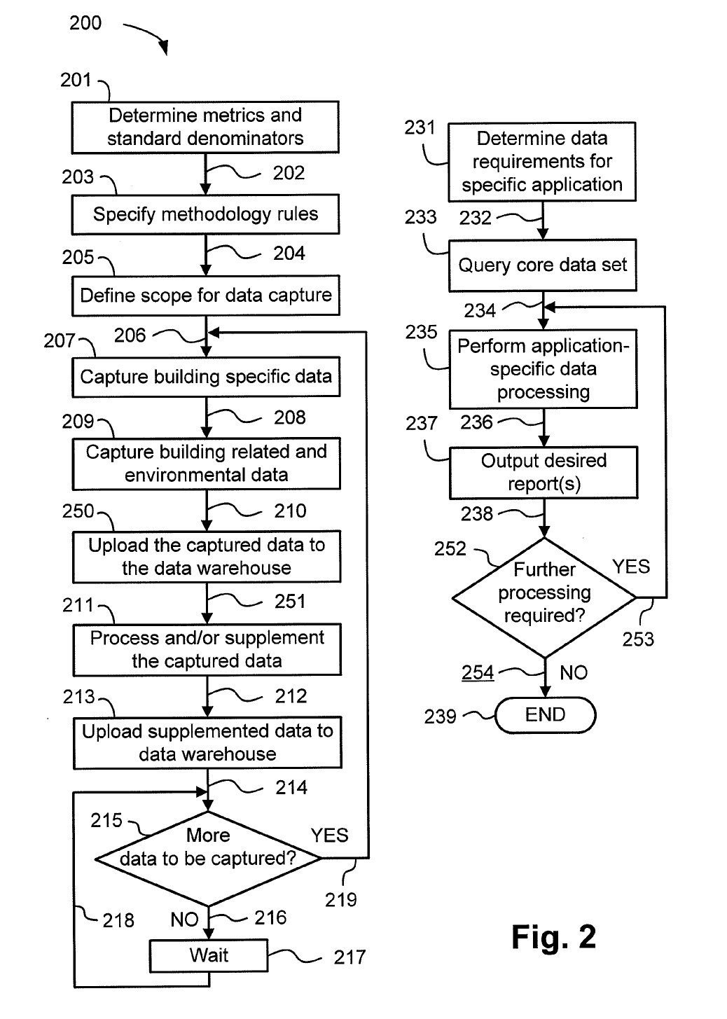

FIG. 2 shows a flow chart of two process fragments 200, 230, the one fragment 200 showing an example of how the ICDS arrangement populates and maintains the ICDS data warehouse, and the other fragment 230 showing how an end user 116 uses the data in the warehouse.

The process fragment 200 commences with a step 201 in which the metrics and standard denominators module 126 determines building specific data capture metrics, environmental externality metrics, and standard denominators that support calculations and reporting which are compliant with at least one international standard for Greenhouse Gas reporting and measurement, where relevant.

The process 200 then follows an arrow 202 to a step 203 which specifies methodology rules which can be encoded into software procedures for execution on the capture methodology module 129. The process 200 then follows an arrow 204 to a step 205 which defines a scope for data capture comprising a hierarchy for classifying data sets including (a) a mandatory data set being a minimum acceptable data collection as defined by the metrics, (b) a preferred data set being a more detailed data collection as defined by the metrics, and (c) an optional data set being a further detailed data collection as defined by the metrics.

The process fragment 200 then follows an arrow 206 to a step 207 in which the data capture platform 104 captures and characterises the building specific data 107, as directed by the set of software procedures based upon the metrics from the step 201 and the rules from the step 203 and executing on the computer platform. The process fragment 200 then follows an arrow 208 to a step 209 in which the data capture platform 111 captures and characterises the environmental externality data 114, as directed by the set of software procedures based upon the metrics from the step 201 and the rules from the step 203 and executing on the computer platform.

The process 200 then follows an arrow 210 to a step 250 which uploads the captured building specific data 107 and the captured building related and environmental data 114 to the data warehouse 131.

The process 200 then follows an arrow 251 to a step 211 which processes and/or supplements the captured data (as depicted by the arrow 135 in FIG. 1). An example of such processing is deriving [CO2e/m2] from fuel sources X fuel intensities/floor area.

The process 200 then follows an arrow 212 to a step 213 which uploads the processed/supplemented data to the data warehouse 125.

Thereafter the process 200 follows an arrow 214 to a testing step 215 which determines if there is any further data to be captured. If there is such data to be captured, then the process 200 follows a YES arrow 219 back to the step 207. If on the other hand there is no further data to be captured, then the process 200 follows a NO arrow 216 to a step 217 which waits for a predetermined period, before looping back, as depicted by an arrow 218, to the testing step 215.

The process 230 commences with a step 231, after an end user has decided that a specific reporting requirement 117 has arisen, which determines the data requirements 119 for the specific report in question. For example, and end user might wish to generate a report, in regard to a portfolio of buildings that are to be reported upon in a specified reporting year. The data needed to generate this report is to be retrieved from the core data set 130 in the ICDS data warehouse 131. After the data requirements have been determined, the process 230 follows an arrow 232 to a step 233 in which a query and processing engine 121, which may be implemented by suitable software executing on a general purpose computer or remotely on a server, queries, as depicted by an arrow 122, the data warehouse 131. The query returns requisite data from the core data set 130, and the process 230 follows an arrow 234 to a step 235 in which the query and processing engine 121 performs application specific processing dictated by the application specification 117. The process 230 then follows an arrow 236 to a step 237 in which the query and processing engine 121 outputs the desired report.

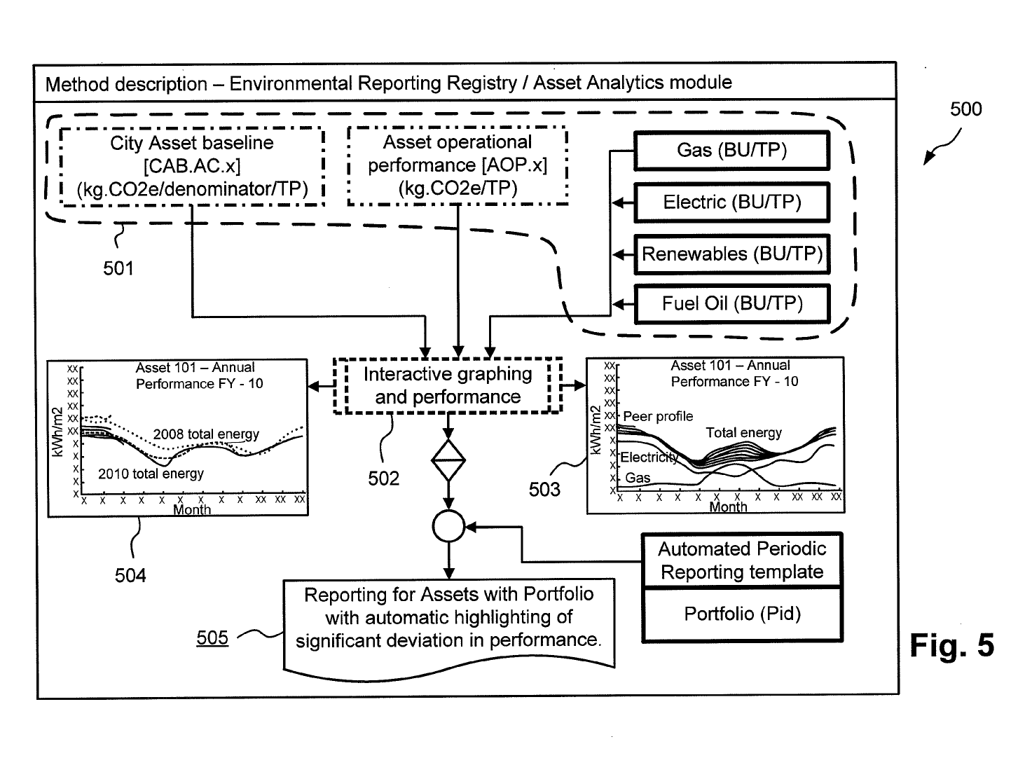

The process fragment 230 then follows an arrow 238 to a decision step 252 which determines if the end user wishes to perform further processing on the data which has been retrieved from the core data set in the step 233. If this is the case then the fragment 230 follows a YES arrow 253 back to the step 235. If however no further processing is required, then the process 230 follows a NO arrow 254 to an end step 239. A specific example is described with reference to FIGS. 4 and 5.

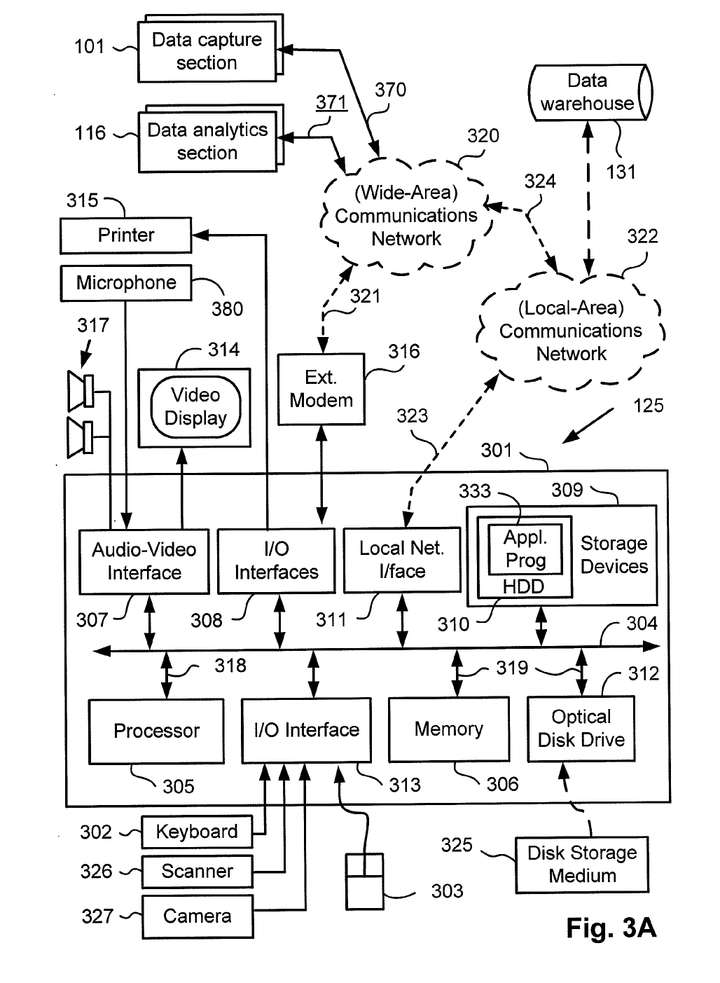

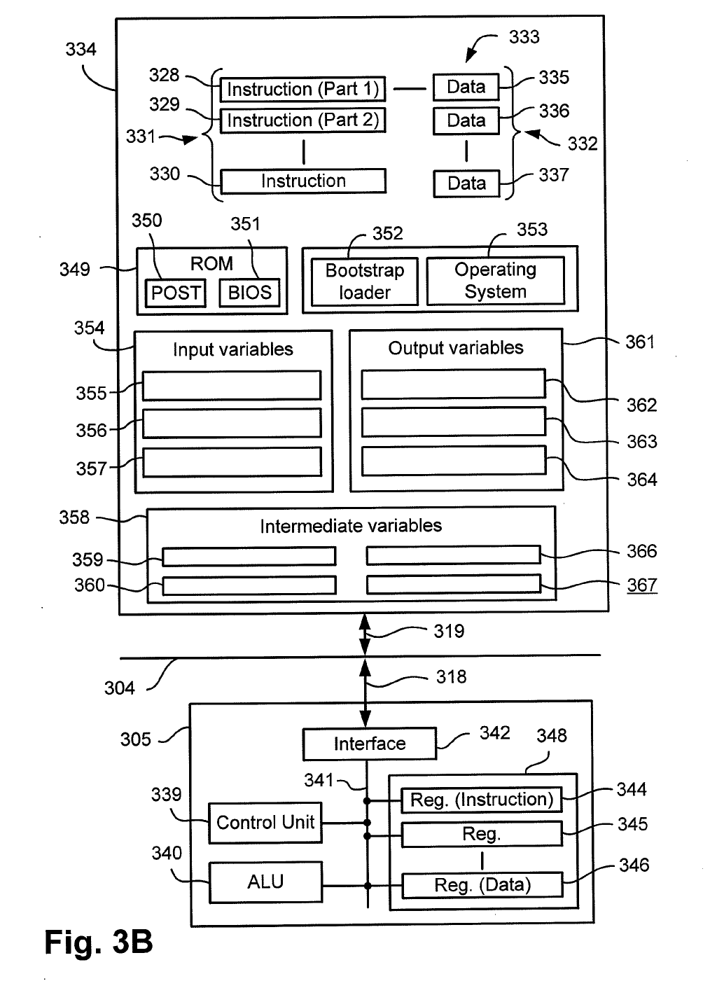

FIGS. 3A and 3B depict an arrangement in which the ICDS platform 125 is implemented using a general-purpose computer system, having therefore the reference numeral 125, upon which the various arrangements described can be practiced. Although the following description is directed primarily at the ICDS platform 125, the data capture and data analytics modules 101, 116 may have similar structural and functional features.

As seen in FIG. 3A, the computer system 125 includes: a computer module 301; input devices such as a keyboard 302, a mouse pointer device 303, a scanner 326, a camera 327, and a microphone 380; and output devices including a printer 315, a display device 314 and loudspeakers 317. An external Modulator-Demodulator (Modem) transceiver device 316 may be used by the computer module 301 for communicating to and from one or more data capture modules such as 101, and one or more data analytics modules such as 116, via respective connections 370, 371 to a communications network 320 which is connected to the computer module 301 via a connection 321. The communications network 320 may be a wide-area network (WAN), such as the Internet, a cellular telecommunications network, or a private WAN. Where the connection 321 is a telephone line, the modem 316 may be a traditional “dial-up” modem. Alternatively, where the connection 321 is a high capacity (e.g., cable) connection, the modem 316 may be a broadband modem. A wireless modem may also be used for wireless connection to the communications network 320.

The computer module 301 typically includes at least one processor unit 305, and a memory unit 306. For example, the memory unit 306 may have semiconductor random access memory (RAM) and semiconductor read only memory (ROM). The computer module 301 also includes an number of input/output (I/O) interfaces including: an audio-video interface 307 that couples to the video display 314, loudspeakers 317 and microphone 380; an I/O interface 313 that couples to the keyboard 302, mouse 303, scanner 326, camera 327 and optionally a joystick or other human interface device (not illustrated); and an interface 308 for the external modem 316 and printer 315. In some implementations, the modem 316 may be incorporated within the computer module 301, for example within the interface 308. The computer module 301 also has a local network interface 311, which permits coupling of the computer system 125 via a connection 323 to a local-area communications network 322, known as a Local Area Network (LAN). As illustrated in FIG. 3A, the local communications network 322 may also couple to the wide network 320 via a connection 324, which would typically include a so-called “firewall” device or device of similar functionality. The local network interface 311 may comprise an Ethernet circuit card, a Bluetooth™ wireless arrangement or an IEEE 802.11 wireless arrangement; however, numerous other types of interfaces may be practiced for the interface 311.

The I/O interfaces 308 and 313 may afford either or both of serial and parallel connectivity, the former typically being implemented according to the Universal Serial Bus (USB) standards and having corresponding USB connectors (not illustrated). Storage devices 309 are provided and typically include a hard disk drive (HDD) 310. Other storage devices such as a floppy disk drive and a magnetic tape drive (not illustrated) may also be used. An optical disk drive 312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 125.

The components 305 to 313 of the computer module 301 typically communicate via an interconnected bus 304 and in a manner that results in a conventional mode of operation of the computer system 125 known to those in the relevant art. For example, the processor 305 is coupled to the system bus 304 using a connection 318. Likewise, the memory 306 and optical disk drive 312 are coupled to the system bus 304 by connections 319. Examples of computers on which the described arrangements can be practiced include IBM-PC's and compatibles, Sun Sparcstations, Apple Mac or alike computer systems.

The ICDS method may be implemented using the computer system 125 wherein the processes of FIG. 2 may be implemented as one or more ICDS software application programs 333 executable within the computer system 125. In particular, the steps of the

ICDS method are effected by instructions 331 (see FIG. 3B) in the software 333 that are carried out within the computer system 125. The software instructions 331 may be formed as one or more code modules, each for performing one or more particular tasks. Accordingly, separate code modules may be implemented for the metrics and standard denominators module 126, the capture methodology module 129, the warehouse software 132, and the review and verification requirements module 134. The ICDS software may also, in regard to one or more of the aforementioned modules, be divided into two separate parts, in which a first part and the corresponding code modules performs the ICDS methods and a second part and the corresponding code modules manage a user interface between the first part and the user.

The ICDS software may be stored in a computer readable medium, including the storage devices described below, for example. The software is loaded into the computer system 125 from the computer readable medium, and then executed by the computer system 125. A computer readable medium having such software or computer program recorded on the computer readable medium is a computer program product. The use of the computer program product in the computer system 125 preferably effects an advantageous apparatus for performing the ICDS methods.

The ICDS software 333 is typically stored in the HDD 310 or the memory 306. The data warehouse 131 is typically stored in the HDD 310, or in an external database, depicted as 131 in FIG. 3A, which communicates with the ICDS platform 125. The ICDS software is loaded into the computer system 125 from a computer readable medium, and executed by the computer system 125. Thus, for example, the software 333 may be stored on an optically readable disk storage medium (e.g., CD-ROM) 325 that is read by the optical disk drive 312. A computer readable medium having such software or computer program recorded on it is a computer program product. The use of the computer program product in the computer system 125 preferably effects an apparatus for the ICDS arrangements.

In some instances, the ICDS application programs 333 may be supplied to the user encoded on one or more CD-ROMs 325 and read via the corresponding drive 312, or alternatively may be read by the user from the networks 320 or 322. Still further, the software can also be loaded into the computer system 125 from other computer readable media. Computer readable storage media refers to any non-transitory tangible storage medium that provides recorded instructions and/or data to the computer system 125 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 301. Examples of transitory or non-tangible computer readable transmission media that may also participate in the provision of software, application programs, instructions and/or data to the computer module 301 include radio or infra-red transmission channels as well as a network connection to another computer or networked device, and the Internet or Intranets including e-mail transmissions and information recorded on Websites and the like.

The second part of the ICDS application programs 333 and the corresponding code modules mentioned above may be executed to implement one or more graphical user interfaces (GUIs) to be rendered or otherwise represented upon the display 314. Through manipulation of typically the keyboard 302 and the mouse 303, a user of the computer system 125 and the application may manipulate the interface in a functionally adaptable manner to provide controlling commands and/or input (as depicted by the dashed arrow 136) to the applications associated with the GUI(s). Other forms of functionally adaptable user interfaces may also be implemented, such as an audio interface utilizing speech prompts output via the loudspeakers 317 and user voice commands input via the microphone 380.

FIG. 3B is a detailed schematic block diagram of the processor 305 and a “memory” 334. The memory 334 represents a logical aggregation of all the memory modules (including the HDD 309, the semiconductor memory 306 and the data warehouse database [not shown]) that can be accessed by the computer module 301 in FIG. 3A. When the computer module 301 is initially powered up, a power-on self-test (POST) program 350 executes. The POST program 350 is typically stored in a ROM 349 of the semiconductor memory 306 of FIG. 3A. A hardware device such as the ROM 349 storing software is sometimes referred to as firmware. The POST program 350 examines hardware within the computer module 301 to ensure proper functioning and typically checks the processor 305, the memory 334 (309,306), and a basic input-output systems software (BIOS)module 351, also typically stored in the ROM 349, for correct operation. Once the POST program 350 has run successfully, the BIOS 351 activates the hard disk drive 310 of FIG. 3A. Activation of the hard disk drive 310 causes a bootstrap loader program 352 that is resident on the hard disk drive 310 to execute via the processor 305.

This loads an operating system 353 into the RAM memory 306, upon which the operating system 353 commences operation. The operating system 353 is a system level application, executable by the processor 305, to fulfill various high level functions, including processor management, memory management, device management, storage management, software application interface, and generic user interface.

The operating system 353 manages the memory 334 (309,306) to ensure that each process or application running on the computer module 301 has sufficient memory in which to execute without colliding with memory allocated to another process. Furthermore, the different types of memory available in the system 125 of FIG. 3A must be used properly so that each process can run effectively. Accordingly, the aggregated memory 334 is not intended to illustrate how particular segments of memory are allocated (unless otherwise stated), but rather to provide a general view of the memory accessible by the computer system 125 and how such is used.

As shown in FIG. 3B, the processor 305 includes a number of functional modules including a control unit 339, an arithmetic logic unit (ALU) 340, and a local or internal memory 348, sometimes called a cache memory. The cache memory 348 typically include a number of storage registers 344-346 in a register section. One or more internal busses 341 functionally interconnect these functional modules. The processor 305 typically also has one or more interfaces 342 for communicating with external devices via the system bus 304, using a connection 318. The memory 334 is coupled to the bus 304 using a connection 319.

The ICDS application program 333 includes a sequence of instructions 331 that may include conditional branch and loop instructions. The program 333 may also include data 332 which is used in execution of the program 333. The instructions 331 and the data 332 are stored in memory locations 328, 329, 330 and 335, 336, 337, respectively. Depending upon the relative size of the instructions 331 and the memory locations 328-330, a particular instruction may be stored in a single memory location as depicted by the instruction shown in the memory location 330. Alternately, an instruction may be segmented into a number of parts each of which is stored in a separate memory location, as depicted by the instruction segments shown in the memory locations 328 and 329.

In general, the processor 305 is given a set of instructions which are executed therein. The processor 1105 waits for a subsequent input, to which the processor 305 reacts to by executing another set of instructions. Each input may be provided from one or more of a number of sources, including data generated by one or more of the input devices 302, 303, data received from an external source across one of the networks 320, 302, data retrieved from one of the storage devices 306, 309 or data retrieved from a storage medium 325 inserted into the corresponding reader 312, all depicted in FIG. 3A. The execution of a set of the instructions may in some cases result in output of data. Execution may also involve storing data or variables to the memory 334.

The disclosed ICDS arrangements use input variables 354, which are stored in the memory 334 in corresponding memory locations 355, 356, 357. The ICDS arrangements produce output variables 361, which are stored in the memory 334 in corresponding memory locations 362, 363, 364. Intermediate variables 358 may be stored in memory locations 359, 360, 366 and 367.

Referring to the processor 305 of FIG. 3B, the registers 344, 345, 346, the arithmetic logic unit (ALU) 340, and the control unit 339 work together to perform sequences of micro-operations needed to perform “fetch, decode, and execute” cycles for every instruction in the instruction set making up the program 333. Each fetch, decode, and execute cycle comprises:

(a) a fetch operation, which fetches or reads an instruction 331 from a memory location 328, 329, 330;

(b) a decode operation in which the control unit 339 determines which instruction has been fetched; and

(c) an execute operation in which the control unit 339 and/or the ALU 340 execute the instruction.

Thereafter, a further fetch, decode, and execute cycle for the next instruction may be executed. Similarly, a store cycle may be performed by which the control unit 339 stores or writes a value to a memory location 332.

Each step or sub-process in the processes of FIG. 2 is associated with one or more segments of the program 333 and is performed by the register section 344, 345, 347, the ALU 340, and the control unit 339 in the processor 305 working together to perform the fetch, decode, and execute cycles for every instruction in the instruction set for the noted segments of the program 333.

The ICDS method may alternatively be implemented in dedicated hardware such as one or more gate arrays and/or integrated circuits performing the ICDS functions or sub functions. Such dedicated hardware may also include graphic processors, digital signal processors, or one or more microprocessors and associated memories. If gate arrays are used, the process flow charts in FIG. 2 are converted to Hardware Description Language (HDL) form. This HDL description is converted to a device level netlist which is used by a Place and Route (P&R) tool to produce a file which is downloaded to the gate array to program it with the design specified in the HDL description.

FIGS. 4A, B and C show an example of the core data set 130 shown in FIG. 1. All data items depicted in FIGS. 4A, B and C form part of the core data set 130. FIGS. 4A, B and C are composite fragments, having respective reference numerals 413, 400 and 414, depicting, in aggregate, the example of the core data set 130. Connection points are shown as encircled numerals 1-8 in FIG. 4A, which connect with corresponding encircled numerals 1′-8′ in FIGS. 4B and 4C.

A specific asset such as the building 102 in FIG. 2 is characterised by a set of data items 405 shown as rectangles with heavy borders. The data item set 405 includes data items such as an asset identifier 406, an asset location 407, and a performance target for the building [in kg.CO2/den./time period]. The term “den” is an abbreviation of the respective denominator (ie m2 or no. rooms, etc), and the time period may be month, quarter or year. In the case of targets, year would be the normal time period.

Examples of building specific data items 107 that are captured for the building 102 in the step 207 in FIG. 2 by the data capture platform 104 are depicted by rectangles with heavy borders such as 401 and 402. The data items 401 and 402 refer respectively to a maximum electric demand figure [in kVA] and a gas consumption figure [in BU per time period] for the building 102. The term “BU” is shorthand for “Billing Units”.

Examples of derived asset specific data items for the building 102 are depicted by rectangles with light borders such as the rectangle 403 which represents carbon emissions generated as a result of steam usage [in kgCO2e/time period] for the building 102. The data item 403 is derived from a building specific data item 404 which represents steam usage for the building 102 [in kgCO2e/BU]. The derived asset specific data item 403 results from applying the processing step 211 in FIG. 2 (see also 135 in FIG. 1) to the captured data item 404 to derive the “supplemented” data item 403.

An example of an environmental externality data item is depicted by a rectangle with a heavy border 409 which represents location weather data for the building 102. A derived data item 410, shown as a rectangle with a light border, represents a location baseline adjustment factor to be applied to data associated with the building 102. The data item 410 is determined by applying the processing step 211 in FIG. 2 (see also 135 in FIG. 1) to the captured data item 409 to derive the “supplemented” data item 410.

Examples of derived asset specific data which is ready for output from the core data set 130 are depicted by rectangles with heavy dash-dot-dot-dash outlines such as a data item designated as 412. This data item 412 represents the asset performance of the building in [kg.0O2e/TP] X4 for each of scope 1, 2 and 3, and total. The term “TP” refers to Time Period and so these data items can be warehoused for monthly, quarterly and yearly time periods.

FIG. 5 depicts a modular analytic plug in 500 configured to perform data mining of the core data set and do the necessary processing to generate a particular report. The modular plug in 500 is depicted as 116 in FIG. 1.

As has been described with reference to FIG. 2, an end user decides that a specific reporting requirement 117 has arisen, which determines the data requirements 119 for the specific report in question. The data needed to generate this report, depicted as 501, is retrieved from the core data set 130 in the ICDS data warehouse 131. The query and processing engine 121, depicted as 502 in FIG. 5, performs application specific processing dictated by the application specification 117 in order to produce required graphic outputs 503, 504, and reports 505 targeted to specific decision making

### INDUSTRIAL APPLICABILITY

The arrangements described are applicable to the building, construction and building maintenance industries, and particularly for the characterising of environmental sustainability of non-residential buildings and use thereof in the design, construction and maintenance of such buildings. The arrangements may also be applied to non-building constructed assets such as infrastructure and public health utilities.

The foregoing describes only some embodiments of the present invention, and modifications and/or changes can be made thereto without departing from the scope and spirit of the invention, the embodiments being illustrative and not restrictive. The ICDS arrangements can be realised in a numbers of ways, including: as an environmental performance database; as a stand-alone desktop or other computer-based media application, with linkage to cloud database; under licence by existing enterprise accounting platforms or funding mechanisms; as a description of method incorporated into legislative mechanisms and policy for the accounting and verification of green claims and operational performance attached to grants or for other purposes, and/or as a series of ‘plug-ins’ to an existing environmental performance database that are expanded and enhanced over time to suit the evolution of needs and sophistication in the sector.

The claims defining the invention are as follows:

1. A method, implemented on a computer platform, for capturing, storing, analysing and reporting operational environmental impacts of a non-residential building or collection of non-residential buildings over time, the method comprising the steps of:
determining a set of building specific data capture metrics, environmental externality metrics, and standard denominators that support calculations and reporting which are compliant with at least one international standard for Greenhouse Gas reporting and measurement;
defining a scope for data capture comprising a hierarchy for classifying data sets as follows:
a mandatory data set being a minimum acceptable data collection as defined by the metrics;
a preferred data set being a more detailed data collection as defined by the metrics; and
an optional data set being detailed data collection as defined by the metrics;
capturing and characterising data, as directed by a set of software procedures based upon the metrics and executing on the computer platform, for the carbon and/or energy intensity of the building and other building related and environmental performance data as specified by the defined data sets;
processing the captured data to determine a core data set comprising the originally captured data and common operational intensity data for the building; and
storing the core data set on an electronically accessible database.

2. A method according to claim 1 wherein the optional data set further comprises subjective commentary as defined by the metrics.

3. A method according to claim 1, further comprising providing review and verification capabilities to satisfy auditing requirements and provide confidence rating of captured data.

4. A method according to claim 1, comprising the further steps of:
specifying a set of data required for decision making and/or reporting requirements;
extracting relevant records from the core data set; and
processing the extracted records to determine the specified data.

5. A method according to claim 4, wherein the decision making and/or reporting requirements relate to, but are not limited to, one or more of the following:
determination of market averages;
determination of building performance against prescribed target(s);
performance of peer comparison;
providing baseline data to demonstrate operational environmental impacts of buildings upon the environment at a city, regional or country level;
reporting performance at the building, group of building or contributing company level, for regulatory or voluntary purposes, using prescribed rules for segregation, aggregation and reporting of data regulatory and voluntary performance;
measuring and verifying energy efficiency or carbon abatement for the purposes of monetisation or trading; and
verification of performance for the purposes of financing linked to performance such as grant allocation.

6. A method according to claim 1, wherein the processing step augments the captured data using environmental externality data that is captured using the environmental externality metrics.

7. A method according to claim 1 further comprising repeating one or more of the method steps to accommodate changes in the at least one international standard, the environmental externality metrics, or the standard denominators.

8. A system, comprising a processor and a memory storing a software program configured to direct the processor to execute a method for capturing, storing, analysing and reporting operational environmental impacts of a non-residential building or collection of non-residential buildings over time, the method comprising the steps of:
determining a set of building specific data capture metrics, environmental externality metrics, and standard denominators that support calculations and reporting which are compliant with at least one international standard for Greenhouse Gas reporting and measurement;
defining a scope for data capture comprising a hierarchy for classifying data sets as follows:
a mandatory data set being a minimum acceptable data collection as defined by the metrics;
a preferred data set being a more detailed data collection as defined by the metrics; and
an optional data set being detailed data collection as defined by the metrics;
capturing and characterising data, as directed by a set of software procedures based upon the metrics and executing on the computer platform, for the carbon and/or energy intensity of the building and other building related and environmental performance data as specified by the defined data sets;
processing the captured data to determine a core data set comprising the originally captured data and common operational intensity data for the building; and
storing the core data set on an electronically accessible database.

9. A system according to claim 8 wherein the optional data set further comprises subjective commentary as defined by the metrics.

10. A system according to claim 8, wherein the method further comprises providing review and verification capabilities to satisfy auditing requirements and provide confidence rating of captured data.

11. A system according to claim 8, wherein the method comprises the further steps of:
specifying a set of data required for decision making and/or reporting requirements;
extracting relevant records from the core data set; and
processing the extracted records to determine the specified data.

12. A system according to claim 11, wherein the decision making and/or reporting requirements relate to, but are not limited to, one or more of the following:
determination of market averages;
determination of building performance against prescribed target(s);
performance of peer comparison;
providing baseline data to demonstrate operational environmental impacts of buildings upon the environment at a city, regional or country level;
reporting performance at the building, group of building or contributing company level, for regulatory or voluntary purposes, using prescribed rules for segregation, aggregation and reporting of data regulatory and voluntary performance;
measuring and verifying energy efficiency or carbon abatement for the purposes of monetisation or trading; and
verification of performance for the purposes of financing linked to performance such as grant allocation.

13. A system according to claim 8, wherein the processing step augments the captured data using environmental externality data that is captured using the environmental externality metrics.

14. A system according to claim 8, wherein the method further comprises repeating one or more of the method steps to accommodate changes in the at least one international standard, the environmental externality metrics, or the standard denominators.

15. A computer readable storage medium having a non-transitory computer program recorded therein, the program being executable by a computer apparatus to make the computer perform a method for capturing, storing, analysing and reporting operational environmental impacts of a non-residential building or collection of non-residential buildings over time, the method comprising the steps of:
determining a set of building specific data capture metrics, environmental externality metrics, and standard denominators that support calculations and reporting which are compliant with at least one international standard for Greenhouse Gas reporting and measurement;
defining a scope for data capture comprising a hierarchy for classifying data sets as follows:
a mandatory data set being a minimum acceptable data collection as defined by the metrics;
a preferred data set being a more detailed data collection as defined by the metrics; and
an optional data set being detailed data collection as defined by the metrics;
capturing and characterising data, as directed by a set of software procedures based upon the metrics and executing on the computer platform, for the carbon and/or energy intensity of the building and other building related and environmental performance data as specified by the defined data sets;
processing the captured data to determine a core data set comprising the originally captured data and common operational intensity data for the building; and
storing the core data set on an electronically accessible database.

16. A computer readable storage medium according to claim 14, wherein the optional data set further comprises subjective commentary as defined by the metrics.

17. A computer readable storage medium according to claim 14, wherein the method further comprises providing review and verification capabilities to satisfy auditing requirements and provide confidence rating of captured data.

18. A computer readable storage medium according to claim 14, wherein the method comprises the further steps of:
specifying a set of data required for decision making and/or reporting requirements;
extracting relevant records from the core data set; and
processing the extracted records to determine the specified data.

19. A computer readable storage medium according to claim 18, wherein the decision making and/or reporting requirements relate to, but are not limited to, one or more of the following:
determination of market averages;
determination of building performance against prescribed target(s);
performance of peer comparison;
providing baseline data to demonstrate operational environmental impacts of buildings upon the environment at a city, regional or country level;
reporting performance at the building, group of building or contributing company level, for regulatory or voluntary purposes, using prescribed rules for segregation, aggregation and reporting of data regulatory and voluntary performance;
measuring and verifying energy efficiency or carbon abatement for the purposes of monetisation or trading; and
verification of performance for the purposes of financing linked to performance such as grant allocation.

20. A computer readable storage medium according to claim 14, wherein the processing step augments the captured data using environmental externality data that is captured using the environmental externality metrics.

21. A computer readable storage medium according to claim 14, wherein the method further comprises repeating one or more of the method steps to accommodate changes in the at least one international standard, the environmental externality metrics, or the standard denominators.
